(19) United States
(12) Patent Application Publication
(10) Pub. No.: US 2025/0053550 A1
(43) Pub. Date: Feb. 13, 2025

(54) Efficient hash table

(71) Applicant: Firebolt Analytics Ltd., Tel Aviv (IL)

(72) Inventors: Alexander Hall, Zurich (CH); Leonard von Merzljak, Munich (DE)

(21) Appl. No.: 18/230,715

(22) Filed: Aug. 7, 2023

(51) Int. Cl. G06F 16/22; G06F 16/2455

(52) U.S. Cl. CPC G06F 16/2255; G06F 16/2456

(57) ABSTRACT

In one embodiment, a device includes a processor to apply a hash function to values in an index column of a database table yielding hash values defining a plurality of buckets of a hash table, copy data from rows of the database table into the hash table as a plurality of tuples, each tuple including a respective key from the index column of the database table, or the respective key from the index column of the database table and at least one value from a row of the database table including the respective key, arrange the plurality of tuples among the buckets in the hash table, a given bucket of the plurality of buckets including multiple tuples of the plurality of tuples, and store the multiple tuples of the given bucket back-to-back without any pointer between the tuples to find at least one next tuple of the multiple tuples.

### FIELD OF THE INVENTION

The present invention relates to computer systems, and in particular, but not exclusively, to hash tables.

### BACKGROUND

A join operation is a way of combining two or more database tables, or parts thereof, into a single table in a relational database. A common way of accessing data from multiple tables in a single Structured Query Language (SQL) operation is to combine the tables with a JOIN clause. There are diverse types of join operations such as Inner Join, Theta Join, Outer Join, and Equi Join.

A hash join is an example of a join operation. Variants of hash join algorithms involve building a hash table or tables from the tuples of one or both of the joined relations, and subsequently probing those tables. Hash joins are used for many types of set-matching operations: inner join; left, right, and full outer join; left and right semi-join; intersection; union; and difference. Moreover, a variant of the hash join can do duplicate removal and grouping. The size of the build and probe phase depends on the size of the different tables and the structure of the join query.

### SUMMARY

There is provided in accordance with an embodiment of the present disclosure, a device including a processor configured to apply a hash function to values in an index column of a database table yielding hash values defining a plurality of buckets of a hash table, copy data from rows of the database table into the hash table as a plurality of tuples, each tuple including a respective key from the index column of the database table, or the respective key from the index column of the database table and at least one value from a row of the database table including the respective key, arrange the plurality of tuples among the plurality of buckets in the hash table, a given bucket of the plurality of buckets including multiple tuples of the plurality of tuples, and store the multiple tuples of the given bucket back-to-back without any pointer between the tuples to find at least one next tuple of the multiple tuples, and a memory configured to store data used by the processor.

Further in accordance with an embodiment of the present disclosure each tuple includes the respective key from the index column of the database table and the at least one value from the row of the database table including the respective key.

Still further in accordance with an embodiment of the present disclosure the processor is configured to generate a pointer to the given bucket but not to individual tuples of the multiple tuples in the given bucket.

Additionally in accordance with an embodiment of the present disclosure the processor is configured to arrange the plurality of tuples of all of the plurality of buckets back-to-back in a single array without pointers to any of the plurality of tuples being stored in the single array.

Moreover, in accordance with an embodiment of the present disclosure the processor is configured to generate pointers to the plurality of buckets, each of the pointers including an offset with respect to the single array.

Further in accordance with an embodiment of the present disclosure the processor is configured to generate respective offsets to indicate respective distances between respective ones of the plurality of buckets.

Still further in accordance with an embodiment of the present disclosure the processor is configured to generate respective offsets to indicate respective distances from a beginning of the single array.

Additionally in accordance with an embodiment of the present disclosure the processor is configured to receive a join query, build the hash table responsibly to receiving the join query, and probe the hash table based on the join query and at least one other database table.

Moreover, in accordance with an embodiment of the present disclosure the processor is configured to retain the hash table after completing execution of the join query for use by another join query.

Further in accordance with an embodiment of the present disclosure the processor is configured to find a maximum length of values of at least one field in the database table, and limit a size of the at least one field of the plurality of tuples encoded in the hash table to the found maximum length.

Still further in accordance with an embodiment of the present disclosure the processor is configured to encode strings in the plurality of tuples with a length indicator of a respective string followed by the respective string.

Additionally in accordance with an embodiment of the present disclosure the processor is configured to divide the database table into blocks, and perform processing of respective ones of the blocks by respective different cores of the processor.

Moreover, in accordance with an embodiment of the present disclosure the respective different cores are configured to copy the data from the respective blocks of the database table to form the tuples.

Further in accordance with an embodiment of the present disclosure the respective different cores are configured to apply the hash function to values in the index column of the respective blocks of the database table, and copy the data from the respective blocks of the database table to form the tuples.

Still further in accordance with an embodiment of the present disclosure the processor is configured to partition the hash values into parts, each of the parts including a respective range of buckets of the plurality of buckets, and the respective different cores are configured to order the plurality of tuples within the respective blocks by the parts.

Additionally in accordance with an embodiment of the present disclosure the respective different cores are configured to copy the plurality of tuples of respective ones of the parts from the blocks into a single array.

There is also provided in accordance with another embodiment of the present disclosure, a method, including applying a hash function to values in an index column of a database table yielding hash values defining a plurality of buckets of a hash table, copying data from rows of the database table into the hash table as a plurality of tuples, each tuple including a respective key from the index column of the database table, or the respective key from the index column of the database table and at least one value from a row of the database table including the respective key, arranging the plurality of tuples among the plurality of buckets in the hash table, a given bucket of the plurality of buckets including multiple tuples of the plurality of tuples, and storing the multiple tuples of the given bucket back-to-back in memory without any pointer between the tuples to find at least one next tuple of the multiple tuples.

Moreover, in accordance with an embodiment of the present disclosure each tuple includes the respective key from the index column of the database table and the at least one value from the row of the database table including the respective key.

Further in accordance with an embodiment of the present disclosure, the method includes generating a pointer to the given bucket but not to individual tuples of the multiple tuples in the given bucket.

Still further in accordance with an embodiment of the present disclosure the arranging includes arranging the plurality of tuples of all of the plurality of buckets back-to-back in a single array without pointers to any of the plurality of tuples being stored in the single array.

Additionally in accordance with an embodiment of the present disclosure, the method includes generating pointers to the plurality of buckets, each of the pointers including an offset with respect to the single array.

Moreover, in accordance with an embodiment of the present disclosure the generating includes generating respective offsets to indicate respective distances between respective ones of the plurality of buckets.

Further in accordance with an embodiment of the present disclosure the generating includes generating respective offsets to indicate respective distances from a beginning of the single array.

Still further in accordance with an embodiment of the present disclosure, the method includes receiving a join query, building the hash table responsibly to receiving the join query, and probing the hash table based on the join query and at least one other database table.

Additionally in accordance with an embodiment of the present disclosure, the method includes retaining the hash table after completing execution of the join query for use by another join query.

Moreover, in accordance with an embodiment of the present disclosure, the method includes finding a maximum length of values of at least one field in the database table, and limiting a size of the at least one field of the plurality of tuples encoded in the hash table to the found maximum length.

Further in accordance with an embodiment of the present disclosure, the method includes encoding strings in the plurality of tuples with a length indicator of a respective string followed by the respective string.

Still further in accordance with an embodiment of the present disclosure, the method includes dividing the database table into blocks, and performing processing of respective ones of the blocks by respective different cores of the processor.

Additionally in accordance with an embodiment of the present disclosure, the method includes the respective different cores copying the data from the respective blocks of the database table to form the tuples.

Moreover, in accordance with an embodiment of the present disclosure, the method includes the respective different cores applying the hash function to values in the index column of the respective blocks of the database table, and copying the data from the respective blocks of the database table to form the tuples.

Further in accordance with an embodiment of the present disclosure, the method includes partitioning the hash values into parts, each of the parts including a respective range of buckets of the plurality of buckets, and the respective different cores ordering the plurality of tuples within the respective blocks by the parts.

Still further in accordance with an embodiment of the present disclosure, the method includes the respective different cores copying the plurality of tuples of respective ones of the parts from the blocks into a single array.

There is also provided in accordance with still another embodiment of the present disclosure, a software product, including a non-transient computer-readable medium in which program instructions are stored, which instructions, when read by a central processing unit (CPU), cause the CPU to apply a hash function to values in an index column of a database table yielding hash values defining a plurality of buckets of a hash table, copy data from rows of the database table into the hash table as a plurality of tuples, each tuple including a respective key from the index column of the database table, or the respective key from the index column of the database table and at least one value from a row of the database table including the respective key, arrange the plurality of tuples among the plurality of buckets in the hash table, a given bucket of the plurality of buckets including multiple tuples of the plurality of tuples, and store the multiple tuples of the given bucket back-to-back in memory without any pointer between the tuples to find at least one next tuple of the multiple tuples.

### BRIEF DESCRIPTION OF THE DRAWINGS

The present invention will be understood from the following detailed description, taken in conjunction with the drawings in which:

FIG. 1 is a block diagram view of a device constructed and operative in accordance with an embodiment of the present invention;

FIG. 2 is a flowchart including steps in a method of operation of the device of FIG. 1;

FIG. 3 is a schematic view of a join query and associated database tables for use in the device of FIG. 1;

FIGS. 4-7 are schematic views of hash table generation in the device of FIG. 1; and

FIG. 8 is a flowchart including steps in a hash table building method in the device of FIG. 1.

### DESCRIPTION OF EXAMPLE EMBODIMENTS

### Overview

The hash table build phase may take a long time and the size of the resulting hash table can be very large. For example, one of the problems with a hash join is that if the hash join runs out of memory, the processor starts to spill some of the hash table to disk, causing the build phase to take even more time. Therefore, there is a need to speed up the build phase of the hash table and reduce the size of the hash table.

Therefore, embodiments of the present invention provide a system and method to speed up the hash table build phase and provide a very significant reduction in the size of the resulting hash table by representing the hash table in a more compact manner. The size of the hash table is reduced in a number of ways including one or more of the following.

In some embodiments, the hash table may be provided in a compact manner by storing the data tuples (from the database table providing the data for the hash table) of the same hash table bucket back-to-back in memory so that the tuples of the same bucket may be found without using memory pointers between the tuples of the same bucket. Therefore, while there are pointers to the buckets of the hash table, the hash table does not include pointers between the tuples in each bucket.

In some embodiments, all the tuples of the hash table are stored in a single array. In some embodiments, all the tuples of the hash table are stored back-to-back in the single array according to an order of the indices of the buckets of the hash table. In other words, the tuples of bucket zero are stored at the beginning of the array, followed by the tuples of bucket 1, and so on. Storing the tuples back-to-back in the single array may include scanning the data of the database table to determine how much space is needed for each bucket. Storing the tuples in a single array may speed up generation of the hash table as well as the probe phase as less time is needed to jump around memory to perform read and write operations.

In some embodiments, the pointer to the buckets may also be compacted by using offsets to identify the locations of the buckets in memory. In some embodiments, the offsets are “base” offsets, and are defined with respect to the beginning of the single array. For example, the offset of bucket 3 is defined as the distance from the beginning of the array to the first tuple of bucket 3. In some embodiments, the offsets are “delta” offsets, and are defined with respect to the previous buckets. For example, the offset of bucket 1 may be the distance (e.g., in bytes) between the beginning of bucket 0 and the beginning of bucket 1, and the offset of bucket 2 may be the distance (e.g., in bytes) between the beginning of bucket 1 and the beginning of bucket 2, and so on. In some embodiments, a combination of base offsets and delta offsets may be used. For example, the offsets for buckets 1 to 4 may be delta offsets, and the offset of bucket 5 may be a base offset, and the offsets for buckets 6-9 may be delta offsets, and so on. If the system wants to find tuples in bucket 8, the location of bucket 5 is first found and then the delta offsets of buckets 6, 7, and 8 may be used to find the location of bucket 8 in memory.

In some embodiments, the values of one or more fields (e.g., numeric fields) in the database table providing the data for the hash table are checked to find the maximum length of the values of the field(s). For example, each of the values in the fields may occupy 8 bytes even though all the values could be encoded with less than 8 bytes. If the maximum length of the values of a given field requires only 3 bytes, then each of the values of that field may be encoded in the tuples of the hash table using 3 bytes.

In some embodiments, as the text values have a variable size, a text value is encoded in its tuple along with a length field indicating the length of the text value (i.e., string), so that the length of the text field taken from the database table may be limited, e.g., to the length of that given text field.

The speed of generation of the hash table is reduced by compacting the size of the hash table as there is less likelihood that the hash table will spill over to the disk. Additionally, in some embodiments, the speed of generation of the hash table may be increased using parallel processing by different processing cores. In some embodiments, different processing cores may process different blocks (e.g., sections) of the database including such operations as computing hash values of keys, and encoding data to form the tuples. In some embodiments, the hash values are partitioned into parts and the different processing cores may order the tuples within the blocks by parts and copy the ordered tuples from the parts to the hash table and generate the offsets to the buckets, as described in disclosed embodiments.

Due to the compact nature of the hash table and the quicker generation of the hash table, embodiments of the present invention improve the way a computer or other processing device works by: providing better computer performance; providing higher processing speed; providing less latency; and reducing storage space which may lead to higher data access speed, reduced power consumption, and reduced bandwidth requirements for storage device read/writes and/or data passing over network connections.

### System Description

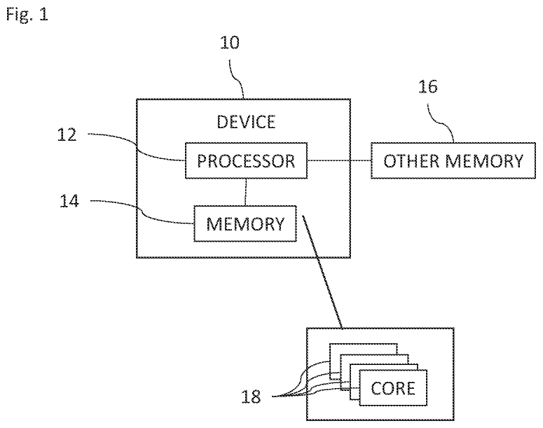

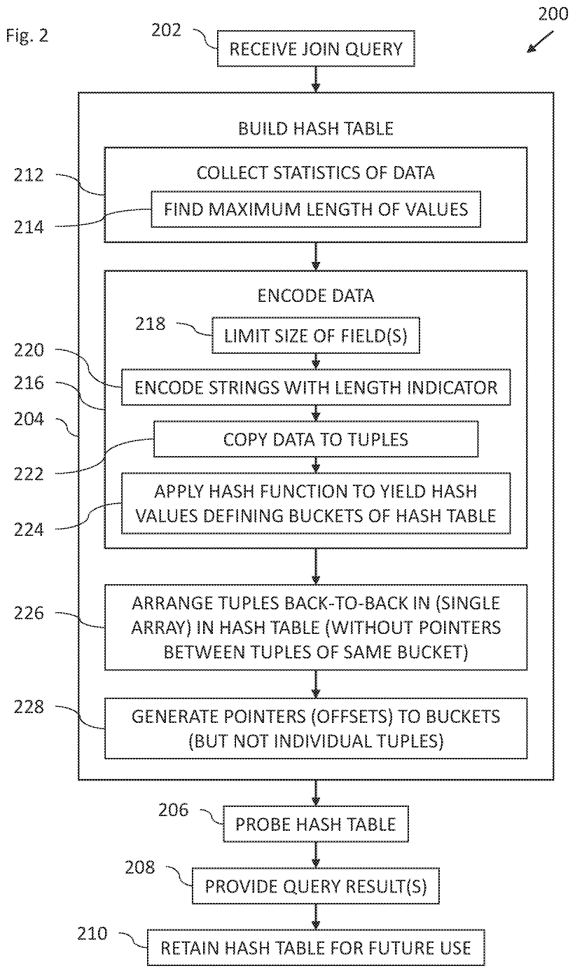

Reference is now made to FIG. 1, which is a block diagram view of a device 10 constructed and operative in accordance with an embodiment of the present invention. The device 10 includes a processor 12 and a memory 14. The memory 14 is configured to store data used by the processor 12. In some embodiments, the processor 12 generates a hash table, which is stored in the memory 14. In other embodiments, the hash table may be stored in another memory 16, which is external to, or peripheral to, device 10. The processor 12 is described in more detail with reference to FIGS. 2-8, and generates a hash table and in some embodiments performs a join operation. The processor 12 may include multiple processing cores 18.

In practice, some or all of the functions of the processor 12 may be combined in a single physical component or, alternatively, implemented using multiple physical components. These physical components may comprise hard-wired or programmable devices, or a combination of the two. In some embodiments, at least some of the functions of the processor 12 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

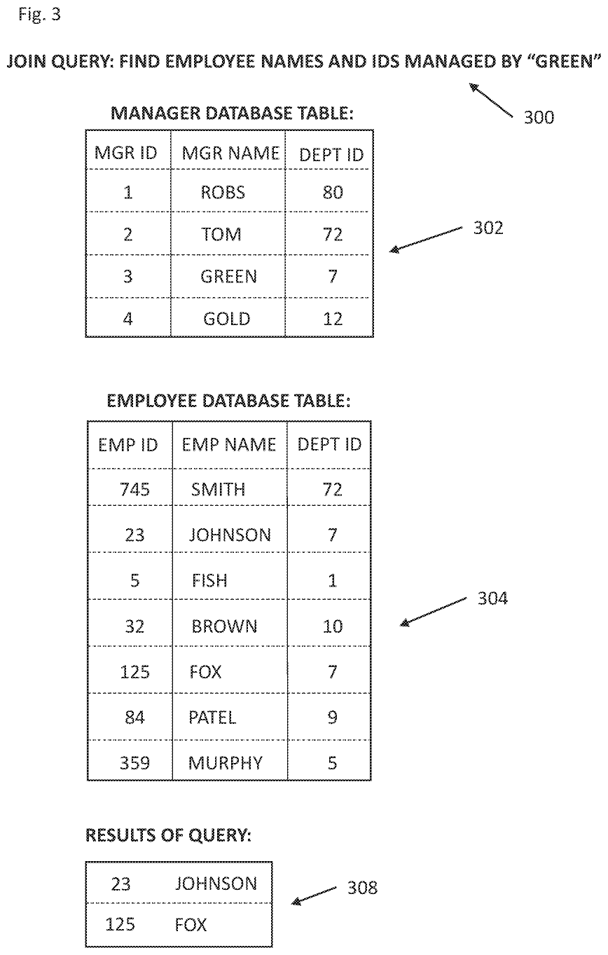

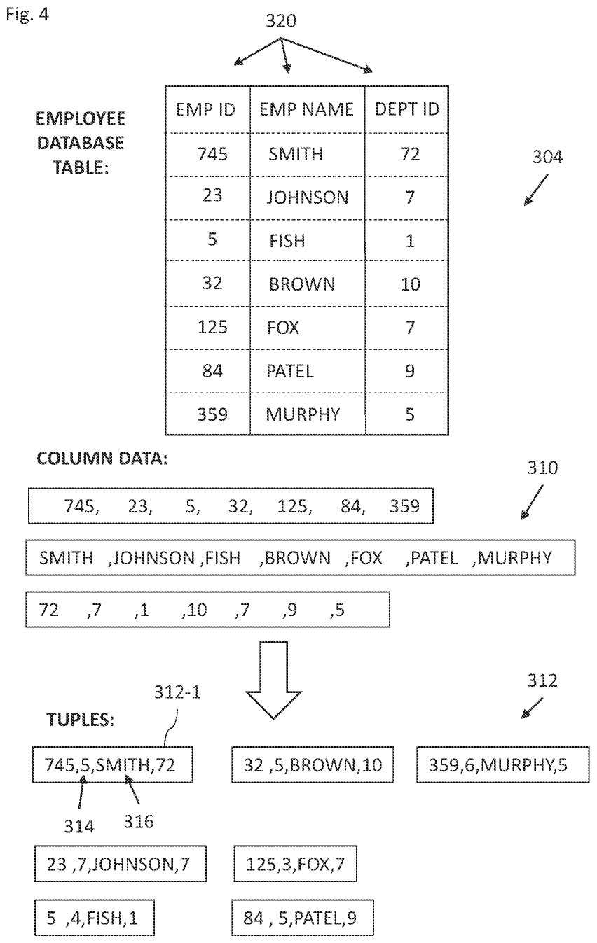

Reference is now made to FIGS. 2 and 3. FIG. 2 is a flowchart 200 including steps in a method of operation of the device 10 of FIG. 1. FIG. 3 is a schematic view of a join query 300 and associated database tables for use in the device 10 of FIG. 1. In some embodiments, the processor 12 is configured to receive the join query 300 (block 202); build a hash table responsibly to receiving the join query 306 (block 204); and probe the hash table based on the join query and at least one other database table (block 206). FIG. 3 shows part of the join query 300 to find employee names and employee identities (IDs) of employees managed by “GREEN”, which entails performing a join of a manager database table 302 and an employee database table 304. As part of the join procedure “build” stage, a hash table is generated from the employee database table 304. The employee database table 304 is an example of a database table and embodiments of the present invention may build a hash table from any suitable database table. The “build” stage is described in more detail with reference to FIGS. 4-8. As part of the probe stage, the manager database table 302 is probed to find the department ID of “GREEN”, i.e., department ID 7, and the hash table is probed to find the employee ID and name in department ID 7, yielding the join query results 308 shown at the bottom of FIG. 3. The processor 12 is configured to provide the query results 308 to the user or entity that issued the query (block 208). In some embodiments, the processor 12 is configured to retain the hash table after completing execution of the join query for use by another join query (block 210). The retained hash table may be stored in the memory 14, or the memory 16, or in any other suitable volatile and/or non-volatile memory.

FIGS. 4-7 are schematic views of hash table generation in the device 10 of FIG. 1. Reference is also made to FIG. 2 and FIG. 4. The processor 12 is configured to collect statistics from the data of employee database table 304 (block 212). The step of block 212 may include the processor 12 being configured to find a maximum length (e.g., size in bytes) of values of one or more fields in the employee database table 304 (block 214). The step of block 212 may also include finding the size of fixed length fields, the total size (e.g., in bytes) of variable length fields such as text fields, and the number of rows in employee database table 304.

The employee database table 304 shown in FIG. 4 includes three columns 320 for three database fields: employee ID; employee name; and department ID. The data of the employee database table 304 is typically stored as column data 310. The length of each of the fields of the employee database table 304 may be much larger than actual data size needed to store the values of the fields. This has been illustrated by the extra spaces shown in the column data 310 of FIG. 4. For example, each of the values in the fields may occupy 8 bytes even though all the values are less than 8 bytes. For example, if the maximum length of the values of a given field requires only 3 bytes, then each of the values of that field are encoded in the tuples of the hash table using 3 bytes. Therefore, in order to compact the data added to the hash table, the data extracted from the employee database table 304 is compacted to remove at least some of the extra spaces.

Therefore, in some embodiments, the processor 12 is configured to encode data from the employee database table 304 (block 216) as follows. The processor 12 is configured to limit the size of one or more fields of all tuples 312 encoded in the hash table to the found maximum length(s) of the field(s) (block 218). For example, the “employee ID” field has a maximum length of 3 characters (or the byte equivalent) and therefore the length of the “employee ID” field encoded in the hash table data may be limited to 3 characters or the byte equivalent. A similar approach may be applied to the “department ID” field. As shown in FIG. 4, the tuples 312 are encoded with the data from the employee database table 304 with the “employee ID” and “department ID” values being limited to the maximum length of the fields with much fewer extra spaces than shown in the column data 310.

The maximum length limitation could be applied to text-based fields. However, another approach may be used to provide a more compact data encoding for text-based fields, such as the “employee name” field. In some embodiments, the processor 12 is configured to encode strings (e.g., text-based fields) in the tuples 312 with a length indicator 314 of the respective string 316, followed by the respective string 316 (block 220). For example, “SMITH” is encoded in one of the tuples 312 as “5, SMITH” as shown in FIG. 4.

The processor 12 is configured to copy data from the employee database table 304 to the tuples 312 (block 222). Each tuple 312 includes the respective key (e.g., employee ID value) from the index column (e.g., employee ID) of the employee database table 304 and zero, or one or more values (e.g., from the employee ID and employee name fields) from the row of the database table including the respective key. Employee ID is chosen to be the key to the hash table for the sake of convenience only. For example, the first row of the employee database table 304 includes employee ID of 745, employee name of SMITH, and department ID of 72. Therefore, tuple 312-1 is encoded as “745,5,SMITH,72”, i.e., employee ID, which is the key, followed by length of the employee name field, followed by the employee name, followed by the department ID.

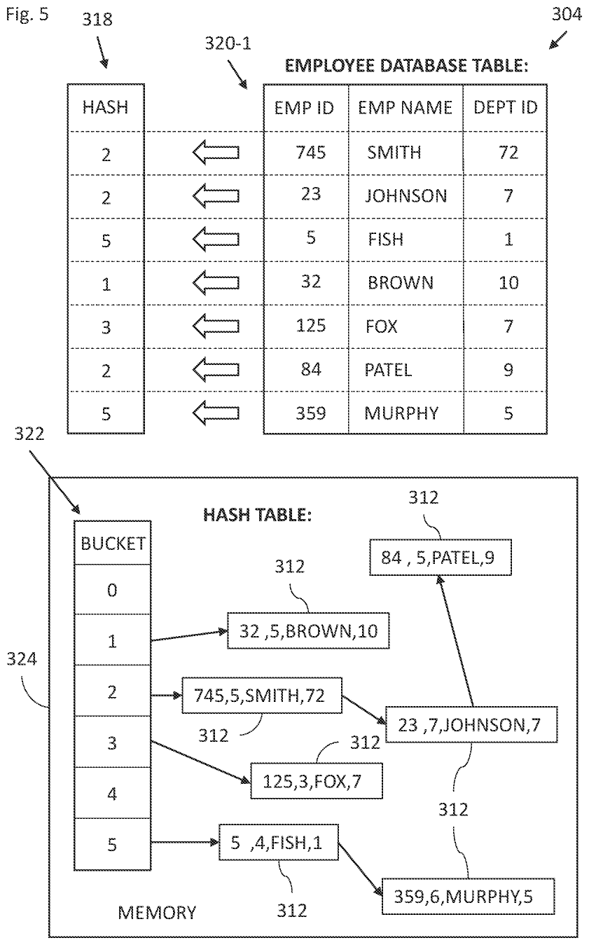

Reference is now made to FIG. 5. Reference is also made to FIG. 2.

The processor 12 is configured to apply a hash function to values in an index column 320-1 (e.g., employee ID) of the employee database table 304 yielding hash values 318 defining buckets 322 of a hash table 324 (block 224). Some of the values in the index column 320-1 map to the same hash value 318 and therefore the same bucket 322. For example, employee IDs 745, 23, and 84 map to hash value and bucket 2. Therefore, bucket 2 includes three tuples 312 as shown in FIG. 5. Similarly, employee IDs 5 and 359 map to hash value and bucket 5. Therefore, bucket 5 includes two tuples 312 as shown in FIG. 5. None of the employee IDs shown in FIG. 5 map to buckets 0 or 4. Therefore, buckets 0 and 4 are shown as being empty of tuples. In order to avoid collisions from having multiple tuples 312 per bucket 322, the number of buckets may be configured. In some embodiments, the number of possible buckets is typically computed as the number of tuples 312 multiplied by two. The hash function may be configured accordingly to spread the hash values 318 over the available buckets as much as possible.

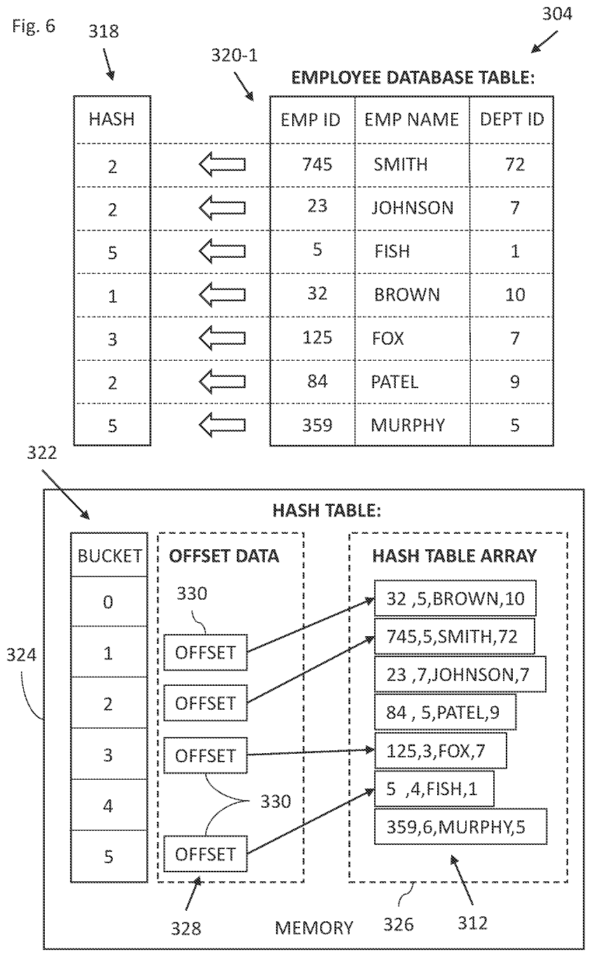

FIG. 5 shows the tuples 312 being connected using pointers, as in the example shown in FIG. 5 the tuples 312 are stored in a non-ordered manner over physical memory and therefore need pointers to navigate between the tuples 312 during the probe phase. The pointers add to the memory used by the hash table. Therefore, embodiments of the present invention provide a more compact hash table when the tuples 312 are stored back-to-back in memory as now described with reference to FIG. 6. Reference is also made to FIG. 2.

The processor 12 is configured to arrange the tuples 312 among the buckets 322 in the hash table 324 (block 226). A given bucket 322 may include one tuple, multiple tuples, or no tuples, as previously described with reference to FIG. 5. The processor 12 is configured to copy data from rows of the employee database table 304 into the hash table 324 as tuples 312. The processor 12 is configured to store the multiple tuples 312 of any given bucket 322 back-to-back in memory without needing any pointer (e.g., memory address or offset) between the tuples 312 of that given bucket 322 to find a next tuple 312 or tuples 312 of that given bucket 322. In some embodiments, the processor 12 is configured to arrange the tuples 312 of all of the buckets 322 back-to-back in a single array 326 without pointers to any of the plurality of tuples 312 being stored in the single array 326 (as there are no pointers to individual tuples-pointers to the buckets are now discussed). In other words, the tuple(s) 312 of bucket 0 are stored at the beginning of the single array 326, followed by the tuple(s) 312 of bucket 1, and so on.

The processor 12 is configured to generate pointers 328 (e.g., memory addresses or offsets with respect to a memory address) to the plurality of buckets 322 (block 228). Each of the pointers 328 includes an offset 330 with respect to the single array 326. The processor 12 is configured to generate a pointer 328 to any given bucket 322 but not to individual tuples 312 in that given bucket 322.

In some embodiments, the processor 12 is configured to generate respective “delta” offsets 330 to indicate respective distances between data of respective ones of the buckets 322. For example, the delta offset of bucket 1, may be the distance (e.g., in bytes) between the beginning of bucket 0 and the beginning of bucket 1, and the delta offset of bucket 2, may be the distance (e.g., in bytes) between the beginning of bucket 1 and the beginning of bucket 2, and so on.

In some embodiments, the processor 12 is configured to generate respective “base” offsets 330 to indicate respective distances of respective ones of the buckets 322 from the beginning of the single array 326. For example, the base offset of bucket 3 may be defined as the distance (e.g., in bytes) from the beginning of the array 326 to the first tuple 312 of bucket 3.

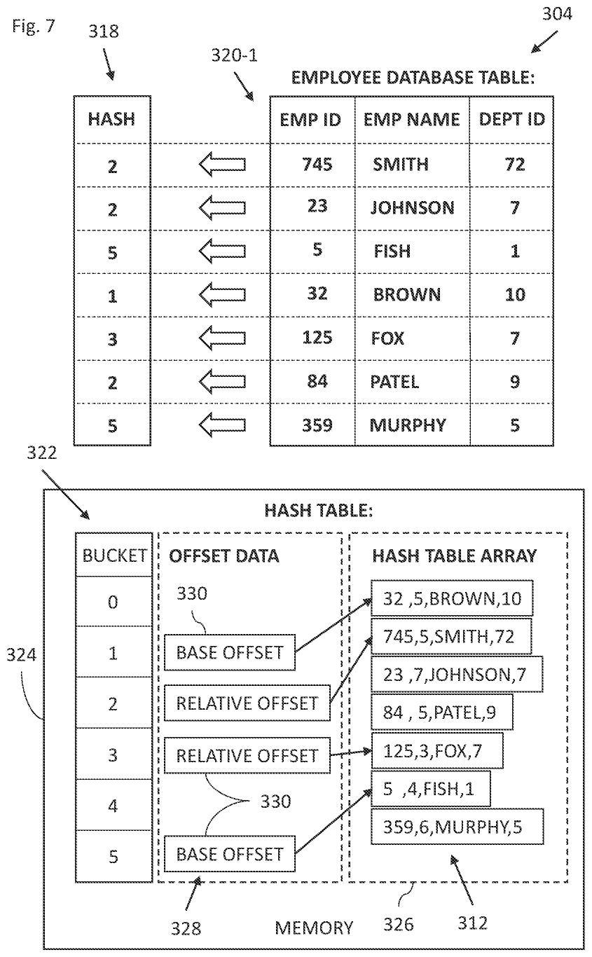

Reference is now made to FIG. 7. Reference is also made to FIG. 2. In some embodiments, a combination of base offsets and delta offsets 330 may be used as shown in FIG. 7. By way of another example, the offsets for buckets 1 to 4 may be delta offsets, and the offset of bucket 5 may be a base offset, and the offsets for buckets 6-9, may be delta offsets, and so on. If the processor 12 wants to find tuples 312 in bucket 8, the location of bucket 5 is first found and then the delta offsets of buckets 6, 7, and 8 may be used to find the location of bucket 8 in memory.

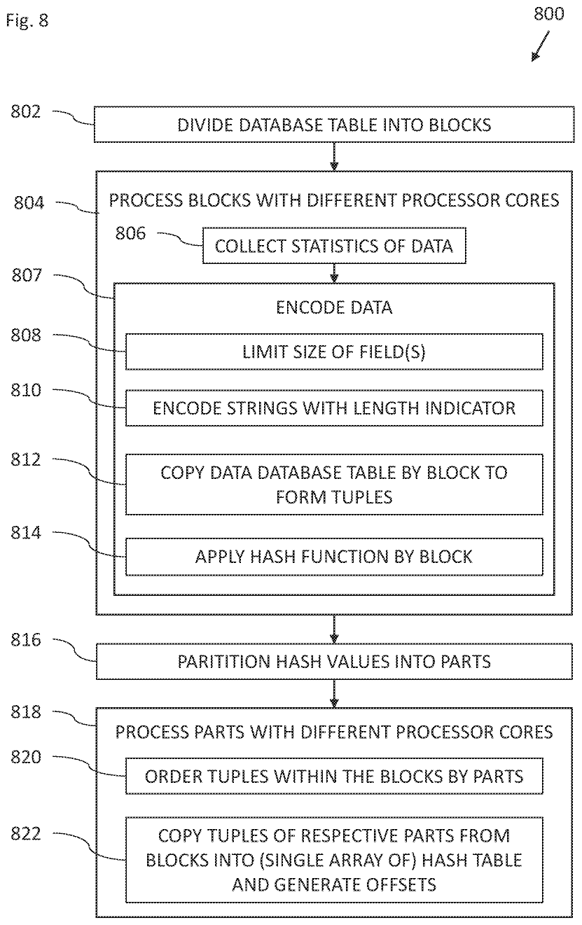

Reference is now made to FIG. 8, which is a flowchart 800 including steps in a hash table building method in the device 10 of FIG. 1. One way to speed up building the hash table 324 (FIG. 7) is to use the processing cores 18 to perform the different stage of building the hash table 324 in parallel, as described in more detail below.

The processor 12 is configured to divide the employee database table 304 into blocks (block 802). For example, rows 1-10 of the employee database table 304 may represent one block, rows 11-20 of the employee database table 304 may represent another block, and so on.

The processor 12 is configured to perform processing of respective ones of the blocks by respective different cores 18 of the processor 12 (block 804). For example, processing core 1 may process block 1, processing core 2 may process block 2, and so on.

The respective processing cores 18 are configured to collect statistics from the data of the different blocks of the employee database table 304 (block 806). For example, processing core 1 may collect statistics from the data of block 1, processing core 2 may collect statistics from the data of block 2, and so on. Some of the statistics from the different blocks may then be aggregated to find statistics for the employee database table 304 as a whole. The step of block 806 may include the processing cores 18 being configured to find a maximum length (e.g., size in bytes) of values of at least one field in the employee database table 304, finding the size of fixed length fields and the total size (e.g., in bytes) of variable length fields such as text fields, total number of rows in the employee database table 304.

The respective processing cores 18 are configured to encode data from the different blocks of the employee database table 304 (block 807). For example, processing core 1 may encode data from block 1, processing core 2 may encode data from block 2, and so on. The processing cores 18 may be configured to limit the size of one or more fields of tuples 312 encoded in the hash table to the found maximum length(s) of the field(s) (block 808). For example, processing core I may limit the size of field(s) of data from block 1, processing core 2 may limit the size of field(s) of data from block 2, and so on. The processing cores 18 may be configured to encode strings (e.g., text-based fields) in the tuples 312 with a length indicator 314 of the respective string 316, followed by the respective string 316 (block 810). For example, processing core 1 may encode strings in the tuples 312 with data from block 1, processing core 2 may encode strings in the tuples 312 with data from block 2, and so on. The processing cores 18 are configured to copy data from the respective blocks of the employee database table 304 to form the tuples 312 (block 812). For example, processing core I may copy data from block 1 to form some of the tuples 312, processing core 2 may copy data from block 2 to form some of the tuples 312, and so on.

The respective different processing cores 18 are configured to apply a hash function to values in the index column 320-1 (FIG. 7) of the respective blocks of the database table to yield the hash values 318 (block 814). For example, processing core 1 may apply the hash function to values in the index column 320-1 of data from block 1 to yield respective ones of the hash values 318, processing core 2 may apply the hash function to values in the index column 320-1 of data from block 2 to yield other respective ones of the hash values 318, and so on. The computed hash values 318 are saved with the respective tuples 312. For example, the hash value 318 of row 1 of the employee database table 304 is saved with the tuple 312 formed from the data from row 1 of the employee database table 304, and so on.

The processor 12 is configured to partition the hash values 318 (or buckets 322) into parts (block 816). Each of the parts includes a respective range of the buckets 322. For example, processor 12 may partition the hash values 318 into 64 parts with part 0 for buckets 0-10, part 2 for buckets 11-20, and so on.

The processing cores 18 are configured to process the parts (block 818). For example, processing core 1 processes the data of part 1, and so on. The respective different processing cores 18 are configured to order the tuples 318 within the respective blocks by the parts (block 820). For example, processing core 1 may order the tuples 318 belonging to part I within their blocks, processing core 2 may order the tuples 318 belonging to part 2 within their blocks, and so on.

The respective different processing cores 18 are configured to copy the tuples 318 of the respective parts from the blocks (back-to-back) into the single array 326 (block 822). For example, processing core 1 reads and processes the ordered tuple data of part 1 (e.g., the tuples 312 of buckets 0-10) and computes how many tuples 312 there are per bucket 322 for the buckets 322 of part 1 (based on the hash values 318 that indicate the buckets associated with each tuple 318), and writes the tuples 312 of part 1 to the relevant buckets 322 based on the hash values 318 computed for each tuple 312 (and stored with each tuple 312) previously. Processing core 1 may also create the offsets 330 for the buckets 322 of part 1 based on the known positions of the first tuples 312 in each respective bucket 322 or the space needed by the tuples 312 in each bucket. Delta offsets 330 may be used by the processor 12 during the step of block 822 and may provide the locations to where to write the tuples 312.

The above steps of blocks 802-822 reduce the number of movements in memory and speed up creation of the hash table 324.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

1. A device comprising:
a processor configured to:
apply a hash function to values in an index column of a database table yielding hash values defining a plurality of buckets of a hash table;
copy data from rows of the database table into the hash table as a plurality of tuples, each tuple including: a respective key from the index column of the database table; or the respective key from the index column of the database table and at least one value from a row of the database table including the respective key;
arrange the plurality of tuples among the plurality of buckets in the hash table, a given bucket of the plurality of buckets including multiple tuples of the plurality of tuples; and
store the multiple tuples of the given bucket in the hash table back-to-back without any pointer between the tuples to find at least one next tuple of the multiple tuples, wherein storing the multiple tuples back-to-back in the hash table without pointers reduces memory usage compared to storing the tuples with pointers; and
a memory configured to store data used by the processor.

2. The device according to claim 1, wherein each tuple includes the respective key from the index column of the database table and the at least one value from the row of the database table including the respective key.

3. The device according to claim 1, wherein the processor is configured to generate a pointer to the given bucket but not to individual tuples of the multiple tuples in the given bucket.

4. The device according to claim 1, wherein the processor is configured to arrange the plurality of tuples of all of the plurality of buckets back-to-back in a single array without pointers to any of the plurality of tuples being stored in the single array.

5. The device according to claim 4, wherein the processor is configured to generate pointers to the plurality of buckets, each of the pointers including an offset with respect to the single array.

6. The device according to claim 5, wherein the processor is configured to generate respective offsets to indicate respective distances between respective ones of the plurality of buckets.

7. The device according to claim 5, wherein the processor is configured to generate respective offsets to indicate respective distances from a beginning of the single array.

8. The device according to claim 1, wherein the processor is configured to:
receive a join query;
build the hash table responsibly to receiving the join query; and
probe the hash table based on the join query and at least one other database table.

9. The device according to claim 8, wherein the processor is configured to retain the hash table after completing execution of the join query for use by another join query.

10. The device according to claim 1, wherein the processor is configured to:
find a maximum length of values of at least one field in the database table; and
limit a size of the at least one field of the plurality of tuples encoded in the hash table to the found maximum length.

11. The device according to claim 1, wherein the processor is configured to encode strings in the plurality of tuples with a length indicator of a respective string followed by the respective string.

12. The device according to claim 1, wherein the processor is configured to:
divide the database table into blocks; and
perform processing of respective ones of the blocks by respective different cores of the processor.

13. The device according to claim 12, wherein the respective different cores are configured to copy the data from the respective blocks of the database table to form the tuples.

14. The device according to claim 12, wherein the respective different cores are configured to:
apply the hash function to values in the index column of the respective blocks of the database table; and
copy the data from the respective blocks of the database table to form the tuples.

15. The device according to claim 14, wherein:
the processor is configured to partition the hash values into parts, each of the parts including a respective range of buckets of the plurality of buckets; and
the respective different cores are configured to order the plurality of tuples within the respective blocks by the parts.

16. The device according to claim 15, wherein the respective different cores are configured to copy the plurality of tuples of respective ones of the parts from the blocks into a single array.

17. A method, comprising:
applying a hash function to values in an index column of a database table yielding hash values defining a plurality of buckets of a hash table;
copying data from rows of the database table into the hash table as a plurality of tuples, each tuple including: a respective key from the index column of the database table; or the respective key from the index column of the database table and at least one value from a row of the database table including the respective key;
arranging the plurality of tuples among the plurality of buckets in the hash table, a given bucket of the plurality of buckets including multiple tuples of the plurality of tuples; and
storing the multiple tuples of the given bucket back-to-back in the hash table in memory without any pointer between the tuples to find at least one next tuple of the multiple tuples, wherein the storing the multiple tuples back-to-back in the hash table without pointers reduces memory usage compared to storing the tuples with pointers.

18. The method according to claim 17, wherein each tuple includes the respective key from the index column of the database table and the at least one value from the row of the database table including the respective key.

19. The method according to claim 17, further comprising generating a pointer to the given bucket but not to individual tuples of the multiple tuples in the given bucket.

20. The method according to claim 17, wherein the arranging includes arranging the plurality of tuples of all of the plurality of buckets back-to-back in a single array without pointers to any of the plurality of tuples being stored in the single array.

21. The method according to claim 20, further comprising generating pointers to the plurality of buckets, each of the pointers including an offset with respect to the single array.

22. The method according to claim 21, wherein the generating includes generating respective offsets to indicate respective distances between respective ones of the plurality of buckets.

23. The method according to claim 21, wherein the generating includes generating respective offsets to indicate respective distances from a beginning of the single array.

24. The method according to claim 17, further comprising:
receiving a join query;
building the hash table responsibly to receiving the join query; and
probing the hash table based on the join query and at least one other database table.

25. The method according to claim 24, further comprising retaining the hash table after completing execution of the join query for use by another join query.

26. The method according to claim 17, further comprising:
finding a maximum length of values of at least one field in the database table; and
limiting a size of the at least one field of the plurality of tuples encoded in the hash table to the found maximum length.

27. The method according to claim 17, further comprising encoding strings in the plurality of tuples with a length indicator of a respective string followed by the respective string.

28. The method according to claim 17, further comprising:
dividing the database table into blocks; and
performing processing of respective ones of the blocks by respective different cores of the processor.

29. The method according to claim 28, further comprising the respective different cores copying the data from the respective blocks of the database table to form the tuples.

30. The method according to claim 28, further comprising the respective different cores:
applying the hash function to values in the index column of the respective blocks of the database table; and
copying the data from the respective blocks of the database table to form the tuples.

31. The method according to claim 30, further comprising:
partitioning the hash values into parts, each of the parts including a respective range of buckets of the plurality of buckets; and
the respective different cores ordering the plurality of tuples within the respective blocks by the parts.

32. The method according to claim 31, further comprising the respective different cores copying the plurality of tuples of respective ones of the parts from the blocks into a single array.

33. A software product, comprising a non-transient computer-readable medium in which program instructions are stored, which instructions, when read by a central processing unit (CPU), cause the CPU to:
apply a hash function to values in an index column of a database table yielding hash values defining a plurality of buckets of a hash table;
copy data from rows of the database table into the hash table as a plurality of tuples, each tuple including: a respective key from the index column of the database table; or the respective key from the index column of the database table and at least one value from a row of the database table including the respective key;
arrange the plurality of tuples among the plurality of buckets in the hash table, a given bucket of the plurality of buckets including multiple tuples of the plurality of tuples; and
store the multiple tuples of the given bucket back-to-back in the hash table in memory without any pointer between the tuples to find at least one next tuple of the multiple tuples, wherein the storing the multiple tuples back-to-back in the hash table without pointers reduces memory usage compared to storing the tuples with pointers.
